(19) United States
(12) Patent Application Publication
(10) Pub. No.: US 2016/0338346 A1
(43) Pub. Date: Nov. 24, 2016

(54) PRECISE TEMPERATURE CONTROLLED TRANSPORT SYSTEM FOR BLOOD AND OTHER BIOLOGICAL MATERIALS

(71) Applicant: David PENSAK, Wilmington, DE (US)

(72) Inventor: David PENSAK, Wilmington, DE (US)

(21) Appl. No.: 15/112,962

(22) PCT Filed: Jan. 21, 2015
(86) PCT No.: PCT/US2015/012207

§ 371 Date: Jul. 20, 2016

Related U.S. Application Data
(60) Provisional application No. 61/930,086, filed on Jan. 22, 2014.

(51) Int. Cl. A01N 1/02; A61J 1/16; F25D 3/08; A61J 1/10

(52) U.S. Cl. CPC A01N 1/0273; A61J 1/10; A61J 1/165; F25D 3/08; A61J 2200/44

(57) ABSTRACT

Transportable containers that utilize phase change materials to maintain blood or other biological material within a precise temperature range for extended periods, without the need for mechanical temperature control, are disclosed. Methods of maintaining such biological materials within a precise temperature range for extended periods, without the need for mechanical temperature control, are also disclosed.

### FIELD OF THE INVENTION

This invention relates to the storage and transportation of blood and/or other biological materials. In particular, the invention provides a transportable container that utilizes phase change materials to maintain the blood or biological material within a precise temperature range for extended periods, without the need for mechanical temperature control.

### BACKGROUND

Biological materials such as blood, or one or more components of blood, are often required in medical procedures to compensate for losses in supply as a result of patient injury, illness, or nature of the medical procedure itself. For example, in accordance with American and European guidelines, blood typically is collected into an anticoagulant comprised of citrate, phosphate and dextrose designed to prevent blood from clotting and maintain cellular function during storage. In most instances, inasmuch as there are few clinical indications for transfusion of whole blood, most blood is processed into its basic components, i.e., red cells (RBCs), platelets and plasma.

When such materials are needed on-site, e.g., in the surgical theater, emergency room, ambulance, or in the field, proper medical practice requires the material to be maintained at particular temperatures. For instance, RBCs and whole blood typically are stored at a temperature between approximately 2° C. and approximately 6° C. Because of its sensitivity to temperature fluctuations, even small deviations from the storage temperature typically results in the blood being spoiled and unusable. The upper limit of 6° C. is essential to minimize the growth of any bacterial contamination in the unit of blood while the lower limit of 2° C. is essential to prevent haemolysis, which can cause fatal bleeding problems or renal failure. As a result, blood units that have been exposed, or have even risked exposure, to temperatures outside of this range cannot be used and must be discarded or used for other purposes that do not involve transfusion. In comparison, platelets must be stored at a temperature between about 20° C. and 24° C. inasmuch as subjecting platelets to lower temperatures (4° C.) markedly reduces their functionality upon transfusion.

Medical procedures requiring use of stored blood (e.g. transfusions or similar blood-based operations) typically have several in-built checkpoints to ensure patients do not suffer elevated risks of adverse reactions to the transfused blood. For example, before a transfusion is started, the blood type of the unit is inspected several times and is cross-matched to ensure compatibility with the blood type of the patient. Should any pre-transfusion steps be neglected, the patient may suffer from adverse reactions (e.g. allergic, febrile, transfusion-related acute lung injury, acute immune hemolytic reaction, etc.) or infections (e.g. bacterial contamination, etc.).

As safeguard against shortage of blood supply or complications due to compatibility issues, additional blood is brought to the operating room before commencing the transfusion. In most circumstances, operating rooms do not have precisely controlled refrigerators for maintaining the temperatures of the blood. However, traditional storage units are equipped with a continuous temperature monitoring system that records temperatures at specified time intervals and alerts hospital staff if temperature thresholds have been exceeded. The staff is required to verify continuous blood storage temperature of the storage units and maintains such documentation. However, this process for recordkeeping and time and temperature auditing for all blood units is tedious, expensive, and subject to re-calibration. Blood supply is often wasted because of these procedural limitations, resulting in increased expenses.

One alternative to mechanical refrigeration is the use of phase change materials (PCMs). A phase-change material (PCM) is a substance with a high heat of fusion which, typically by melting and solidifying at a certain temperature, is capable of storing and releasing large amounts of energy. Heat is absorbed or released when the material changes from solid to liquid and vice versa; thus, PCMs are classified as latent heat storage (LHS) units. Initially, the solid-liquid PCMs behave like sensible heat storage (SHS) materials; i.e., their temperature rises as they absorb heat. However, when PCMs reach the temperature at which they change phase (their melting temperature) they absorb large amounts of heat at an almost constant temperature. The PCM continues to absorb heat without a significant rise in temperature until all the material is transformed to the liquid phase. When the ambient temperature around a liquid material falls, the PCM solidifies, releasing its stored latent heat. Many PCMs are available in any required temperature ranges from −5° C. up to 190° C.

PCM-containing storage and transport systems have been used for the transport of temperature-sensitive materials, such as blood. Some currently available systems utilize rigid panels, such as by lining a box-shaped container with PCM-containing panels, and placing the temperature-sensitive material within the lined container. For example, U.S. Patent Pub. No. 2008/0099492 discloses a container having flexible outer walls and insulating inner panels, with packages of PCMs inserted between the outer walls and the insulating inner panels. U.S Patent Pub. No. 2011/0248038 discloses a kit that is assembled into a bulk shipping container, which includes multiple PCM-containing panels that are slipped into jackets within the container.

A need exists in the art for more precise temperature control of certain materials, such as blood, that cannot tolerate fluctuation in temperature for even a short time during transport. The present invention satisfies this need.

### SUMMARY OF THE INVENTION

One aspect of the invention features a container comprising one or more side, top, bottom and/or internal walls defining one or more internal spaces, wherein one or more of the walls is or includes an enclosure in which is disposed a phase change material, wherein the one or more internal spaces are of a size and shape such that contents of the container, when placed within the one or more internal spaces, are in substantially direct contact with at least one enclosure containing the phase change material. In one embodiment, the contents of the container are in substantially direct contact with at least two enclosures containing the phase change material. More particularly, the contents of the container are surrounded by one or more enclosures containing the phase change material.

In certain embodiments, the phase change material has a melting temperature range within ±2° C. of a pre-determined temperature. In particular, the phase change material has a melting temperature range selected from: (1) between about 2° C. and to about 6° C.; and (2) about 20° C. to about 24° C. In certain embodiments, the container, when closed, maintains the contents at the pre-determined temperature range for up to about 18 hours.

In certain embodiments, the container is designed to contain contents comprising packages of biological materials. In one embodiment, the biological materials include blood or components of blood, and the packages may be referred to as “blood bags”.

The container may further comprise a device that indicates whether the container is opened after it is initially closed with the contents inside. Alternatively or additionally, it may comprise a thermometer for measuring the temperature of the interior of the container and/or the contents of the container.

In another embodiment, the container comprises one or more internal walls defining at least two internal spaces, wherein the internal walls are or include enclosures containing the phase change material.

The aforementioned enclosures can be disposed within a shell. The container may comprise insulation between the enclosure and the shell. In certain embodiments, the insulation comprises a vacuum-sealed material.

Another aspect of the invention features a method of maintaining the temperature of a material within a pre-determined range for up to a pre-determined time without the use of mechanical heating or refrigeration. The method comprises: (a) providing a container comprising one or more side, top, bottom and/or internal walls defining one or more internal spaces, wherein one or more of the walls is or includes an enclosure in which is disposed a phase change material having a melting point within the pre-determined temperature range, wherein the one or more internal spaces are of a size and shape such that contents of the container, when placed within the one or more internal spaces, are in substantially direct contact with at least one enclosure containing the phase change material; (b) equilibrating the material and the container to within the pre-determined temperature range; (c) placing the material into the internal space of the container as its contents; (d) closing the container; and (e) maintaining the container in the closed condition for up to the pre-determined time; whereby the temperature of the material is maintained within the pre-determined range for up to the pre-determined time without the use of mechanical heating or refrigeration.

In certain embodiments, the pre-determined temperature range is between about 2° C. and about 6° C. or between about 20° C. and about 24° C., though other temperature ranges may be selected. In certain embodiments, the pre-determined time is about 18 hours. The biological material is typically contained within a package. In one embodiment, the material comprises one or more blood bags, containing whole blood or components of blood, such as RBCs or platelets.

In the method, the container can further comprise a device that indicates whether the container is opened after it is initially closed with the material inside. Alternatively or additionally, it may comprise a thermometer for measuring the temperature of the interior of the container and/or the contents of the container.

In one embodiment, the packages of biological material and the container are equilibrated to the temperature range in a mechanical refrigeration unit and the packages are transferred from the mechanical refrigeration unit to the container. The packages can be returned to a mechanical refrigeration unit if the container remains closed during the time the packages are contained within the closed container outside the mechanical refrigeration unit and the pre-determined time period is not reached.

Other features and advantages of the invention will be understood from the drawings, detailed description and examples that follow.

### BRIEF DESCRIPTION OF THE DRAWINGS

FIG. 1 shows a portion of an embodiment of the invention, as described in Example 1. FIG. 1A shows an enclosure comprising a LOKSAK™ HDPE bag containing a PCM in solid form. FIG. 1B shows the enclosure containing a PCM in liquid form.

FIG. 2 shows an embodiment of the invention as described in Example 1. Two enclosures are inserted into a TUPPERWARE® plastic container (the “shell”). FIG. 2A shows the entire container, while FIG. 2B shows a close-up.

FIG. 3 shows an alternative embodiment of the invention, where the shell is made of rigid material, such as glass, plexiglass, or other plastic (e.g., polyethylene, polycarbonate, and the like). This embodiment comprises a foam-type insulating material on the internal surfaces of the shell. The enclosures are inserted into this insulation-lined shell and the material to be kept at the specific temperature is inserted between the enclosures. FIG. 3A is a view of the entire embodiment, while FIG. 3B is a top view looking into the shell.

FIG. 4 shows two embodiments of insulation material for use between the enclosure(s) and the shell. FIG. 4A shows ping-pong balls contained within a plastic bag on which a vacuum has been drawn, sufficient to remove most of the air from the bag but not enough to collapse the balls. FIG. 4B shows Perlite contained within a plastic bag on which a vacuum has been drawn, sufficient to remove most of the air from the bag but not enough to collapse the structure of the Perlite.

### DETAILED DESCRIPTION OF THE INVENTION

All percentages expressed herein are by weight of the total weight of the composition unless expressed otherwise. All ratios expressed herein are on a weight (w/w) basis unless expressed otherwise.

Ranges may be used herein in shorthand, to avoid having to list and describe each value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method” or “a fiber” includes a plurality of such “methods”, or “fibers.” Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of”.

The methods and compositions and other advances disclosed herein are not limited to particular equipment or processes described herein because such equipment or processes may vary. Further, the terminology used herein is for describing particular embodiments only and is not intended to limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

The term “single package” means that the components of a kit are physically associated, in or with one or more containers, and considered a unit for manufacture, distribution, sale and/or use. Containers include, but are not limited to, bags, boxes or cartons, packages of any type or design or material, over-wrap, shrink-wrap, affixed components (e.g., stapled, adhered, or the like), or combinations of any of the foregoing.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, or view a visual message, for example, instructions on how to use the kit, or safety or technical information about one or more components of a kit. Examples of information that can be provided as part of a virtual kit include instructions for assembly, instructions for use, and safety information such as material safety data sheets.

The present invention springs in part from the inventor's development of a consistent way to maintain the temperature of a temperature-sensitive material within a precise temperature range for up to several hours without the use of mechanical heating or refrigeration. The devices and methods of the invention are particularly applicable to biological materials, such as blood or components of blood, which are required to be maintained within a constant and narrow temperature range to avoid spoilage and loss of utility. The invention utilizes a system by which the temperature-sensitive material is maintained in close proximity to or in contact with an enclosure containing a phase-change material having a melting point within the temperature range required by the material. This enables consistent maintenance of the material at the requisite temperature, whereas containers of the prior art do not.

Thus, one aspect of the invention features a container comprising one or more side, top, bottom and/or internal walls defining one or more internal spaces, wherein one or more of the walls comprises an enclosure in which is disposed a phase change material (PCM), wherein the one or more internal spaces are of a size and shape such that contents of the container, when placed within the one or more internal spaces, are in substantially direct contact with at least one enclosure containing the phase change material. Preferably, most or all of the contents of the container are in substantially direct contact with the enclosure(s) containing the PCM.

The contents of the container can be any material for which precise temperature control is desired for up to a pre-determined time. In certain embodiments, the material is a biological material, such as a biological fluid, tissue or organ. In particular embodiments, the biological material is blood or a component of blood, such as RBCs, plasma, serum or platelets. In an exemplary embodiment, the biological material is whole blood or RBCs, which typically is disposed in a flexible plastic bag and referred to as a “unit” of blood.

The PCM utilized in the container is selected based on the temperature range desired for the container contents. In one embodiment, the PCM is a solid-liquid PCM that has a melting point within the temperature range desired for the contents of the container. PCMs with melting points over a wide range of temperatures are known in the art, and many are commercially available.

In particular embodiments, the PCM melting point is selected to be within ±2° C. of a pre-determined temperature (sometimes referred to herein as a “pre-determined temperature range.” The pre-determined temperature preferably is selected from a temperature between the freezing point of water and room temperature in a temperate environment. For illustrative purposes, the pre-determined temperature may be selected from 0° C., 1 ° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C. and 25° C. For biological materials, PCMs with melting points in the range of about 2° C. to about 8° C. are particularly suitable. For whole blood or RBCs, PCMs with melting points in the range of about 2° C. to about 6° C. are suitable. In a particular embodiment, a PCM with a melting point of about 4° C. is particularly suitable. For platelets, PCMs with melting points in the range of about 20° C. to about 24° C. are suitable. In a particular embodiment, a PCM with a melting point of about 22° C. is particularly suitable.

In one embodiment, the PCMs comprise esters of long chain fatty acids (e.g, derived from vegetable materials). Examples of PCMs suitable for use in the present invention include, but are not limited to PureTemp (Entropy Solutions, Inc or PCM-SP from Rubitherm. Other PCMs are well known in the art (see, e.g., Sharma et al., 2009, “Review on Thermal Energy Storage with Phase Change Materials and Applications,” Renewable and Sustainable Energy Reviews 13: 318-345).

The enclosure(s) for the PCM can be made of any material, as long as the material is capable of enclosing the PCM for at least the pre-determined time and any additional time needed to equilibrate the PCM at the desired temperature range. Accordingly, the material comprising the enclosure should be substantially inert to the PCM; i.e., not reactive with or degraded by the PCM. Additionally, in certain embodiments, at least the portion PCM enclosure facing the container contents is a flexible material, such that close contact between the enclosure and the contents of the container is better achieved. In certain embodiments, the enclosure is made of a flexible polymer, such as polyethylene. In a particular embodiment, a high density polyethylene (HDPE) is utilized. Suitable HDPE enclosures can be obtained commercially, e.g., LOKSAK, Inc., Naples, Fla., or they can be custom made to suit particular specifications. Other materials suitable for constructing the PCM enclosure include, but are not limited to, polypropylene or fiberglass fabric coated with polytetrafluoroethylene.

The container can be made solely of PCM enclosures, i.e. the enclosures themselves forming the one or more side, top or bottom walls that make up the container. Alternatively, the PCM enclosures can be contained in an outer container, sometimes referred to herein as a “shell.” The use of a shell is advantageous in supplying form and rigidity to an article that otherwise may be too flexible to be practicable. The shell can be composed of any material customarily used for such purpose, including plastic, glass, metal, wood, cardboard, or similar materials or combinations thereof. In certain embodiments, the PCM enclosures are disposed within the shell substantially in contact with the shell. In other embodiments, insulation is disposed between the enclosures and the shell. In particular embodiments, the insulation utilizes vacuum packed insulating materials, such as hollow spheres (ping pong balls) or porous material (perlite, Styrofoam).

The container, or the container-with-shell, can be of any size or shape suitable for its intended purpose. The size and shape of the internal space(s) of the container should be designed with the contents in mind; i.e., the contents should fit snugly into the space(s), such that the contents are in substantially direct contact with the PCM-containing enclosures, as mentioned above.

The container can be adapted to hold multiple contents, e.g., two or more units of blood. In certain embodiments, this is accomplished by defining two or more internal spaces in the container with one or more internal walls that can be composed of a PCM enclosure or another material to which a PCM enclosure is abutted or attached. In preferred embodiments, each internal space thus defined comprises PCM enclosures facing toward the internal spaces where the contents are lodged.

The container is designed to be opened to receive the contents, and then closed once the contents have been placed therein, thereby excluding the ambient environment. In one embodiment, the container comprises as device, such as a tamper-sensitive tape or seal, which indicates whether the container is opened after it has been closed with the contents inside. RFID devices could signal or record if the container had been opened. Similarly, incorporation of a piezo-electric material can enable an electric charge to be generated on opening which would cause a visible or electrically measurable signal. The skilled artisan will appreciate that there are numerous ways to determine if the container has been opened, and how many times (and for how long) the container has been opened.

Additionally, the container can comprise a thermometer to measure the temperature on or within the container. In one embodiment, one or more liquid crystal thermometers (e.g., in tape form) may be attached to the surface of a container to facilitate confirming the temperature of the PCM.

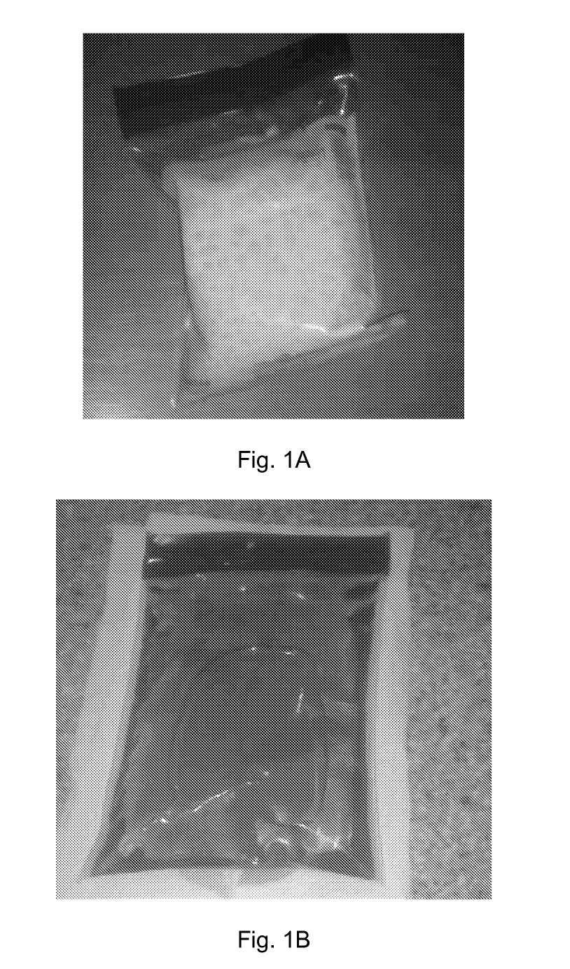

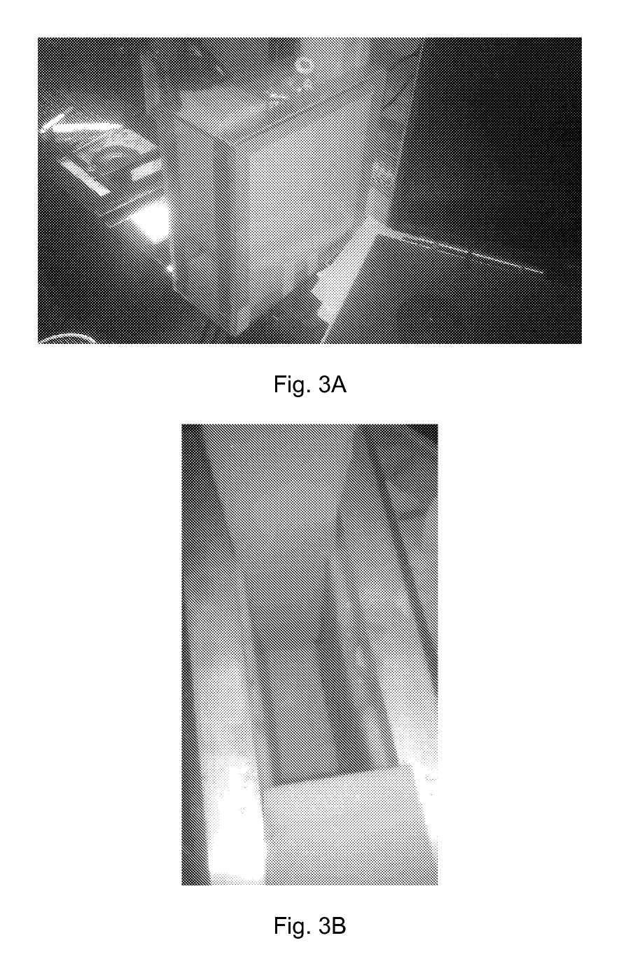

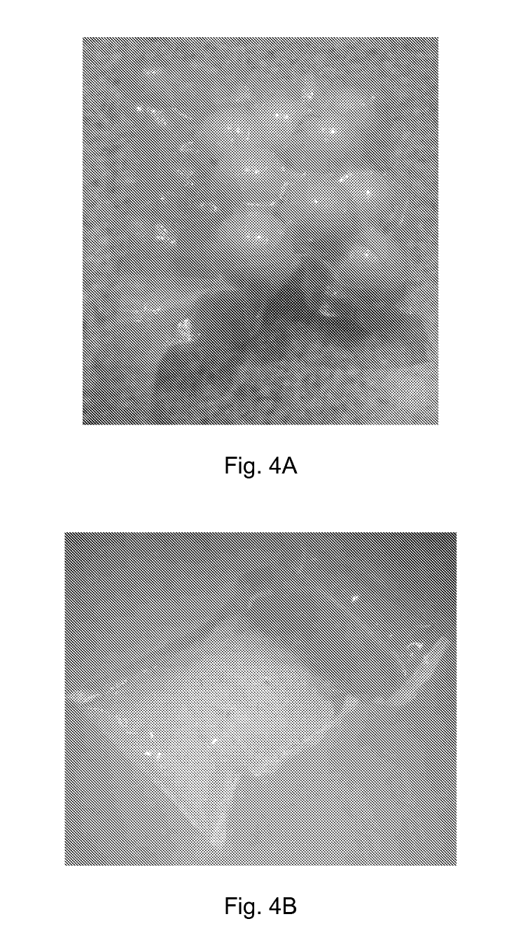

Embodiments of the container are shown in FIGS. 1-3. Embodiments of the insulating material are shown in FIG. 4.

Another aspect of the invention features a method for maintaining the temperature of a material within a pre-determined range for up to a pre-determined time without the use of mechanical heating or refrigeration. The method comprises (1) providing a container as described above, comprising enclosures of PCM having a melting point within the pre-determined temperature range; (2) equilibrating the material and the container to within the pre-determined temperature range; (3) placing the material into the internal space of the container as its contents; (4) closing the container; and (5) maintaining the container in the closed condition for up to the pre-determined time. Thus, the temperature of the material is maintained within the pre-determined range for up to the pre-determined time without the use of mechanical heating or refrigeration.

The material to be protected can be any material for which precise temperature control is desired for up to a pre-determined time period. In certain embodiments, the material is a biological material, such as a biological fluid, tissue or organ. In particular embodiments, the biological material is blood or a component of blood, such as a plasma or serum. In an exemplary embodiment, the biological material is whole blood, which typically is disposed in a flexible plastic bag as a “unit” of blood.

The PCM utilized in the container is selected based on the temperature range desired for the container contents. In one embodiment, the PCM is a solid-liquid PCM that has a melting point within the temperature range desired for the contents of the container. PCMs with melting points over a wide range of temperatures are known in the art, and many are commercially available. For biological materials, PCMs with melting points in the range of about 2° C. to about 8° C., or within the range of about 18° C. to about 24° C., are particularly suitable. For whole blood and RBCs, PCMs with melting points in the range of about 2° C. to about 6° C. are suitable. In a particular embodiment, a PCM with a melting point of about 4° C. is particularly suitable. For platelets, PCMs with melting points in the range of about 20° C. to about 24° C. are suitable. In a particular embodiment, a PCM with a melting point of about 22° C. is particularly suitable.

The pre-determined time can be any period of time during which it is desired to maintain the precise temperature range without mechanical refrigeration or heating. In one embodiment, the time encompasses the amount of time required to transport the material to a location, such as a surgical theater or emergency room, conduct any medical procedures occurring therein, and return the material to the mechanical refrigeration or heating unit. Such time is typically at least one hour, ranging up to several hours. In certain embodiments, the time is up to about 1, 2, 3, 4, 5, 6, 7, 8, 9, 10, 11 or 12 hours. In other embodiments, the time is longer, e.g., 15, 18, 21 or 24 hours.

In certain embodiments, the duration the material is maintained within the container after closure is recorded. In particular embodiments, the container comprises a device that indicates whether the container is opened after it is initially closed with the material inside. In other embodiments, the container comprises a thermometer to measure the temperature on or within the container.

In particular embodiments, the temperature is maintained within ±2° C. of a pre-determined temperature (sometimes referred to herein as a “pre-determined temperature range.” The pre-determined temperature preferably is selected from a temperature between the freezing point of water and room temperature in a temperate environment. For illustrative purposes, the pre-determined temperature may be selected from 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C. and 25° C. In exemplary embodiments, the material to be temperature-protected comprises units of blood or blood components, and the temperature range is between about 2° C. and about 6° C. or between about 20° C. and 24° C.

Typically, the units of blood or blood components (blood bags) and the container comprising the selected PCM are equilibrated to the temperature range in a mechanical refrigeration unit and the blood bags are transferred from the mechanical refrigeration unit to the container. The container is transported to the location where the blood may be needed. If the blood is needed, the container is opened and the blood bags are removed for use. If the blood is not needed, the container can remain closed, and the blood bags can be returned to the mechanical refrigeration unit if the pre-determined time is not exceeded.

Thus, this relatively simple and straightforward system can be used to ensure that the blood or other biological material remains within its safe temperature window without mechanical temperature control, and thereafter can be returned to a central storage facility without the need for expensive and time-consuming auditing and record-keeping. Of particular advantage to the storage and transport of blood, the end result is that medical personnel can requisition enough blood to meet the needs of the patient(s), and any unused blood can be safely returned to a blood bank or other storage facility. This will improve patient care and decrease waste.

The following examples are provided to describe the invention in greater detail. They are intended to illustrate, not to limit, the invention.

### Example 1

This example describes the construction of a prototype temperature control system of the present invention. The prototype container system included two enclosures made of LOKSAK® HDPE bags (LokSak, Inc., Naples, Fla.) that were filled with PURETEMP™ 4 PCM (Entropy Solutions, Inc., Plymouth Minn. 55441), having a solid-to-liquid phase transition temperature of 4° C. The PCM was colored orange-red to more easily detect any leaks. The enclosures were inserted into a TUPPERWARE® polyethylene container as the shell, having a size sufficient to accommodate the two enclosures and a third bag approximately the same size as a conventional blood bag sandwiched between them, such that the enclosures were in contact with the blood bag. In the prototype, the blood bag was filled with saline solution, Ringer's solution or blood prior to testing.

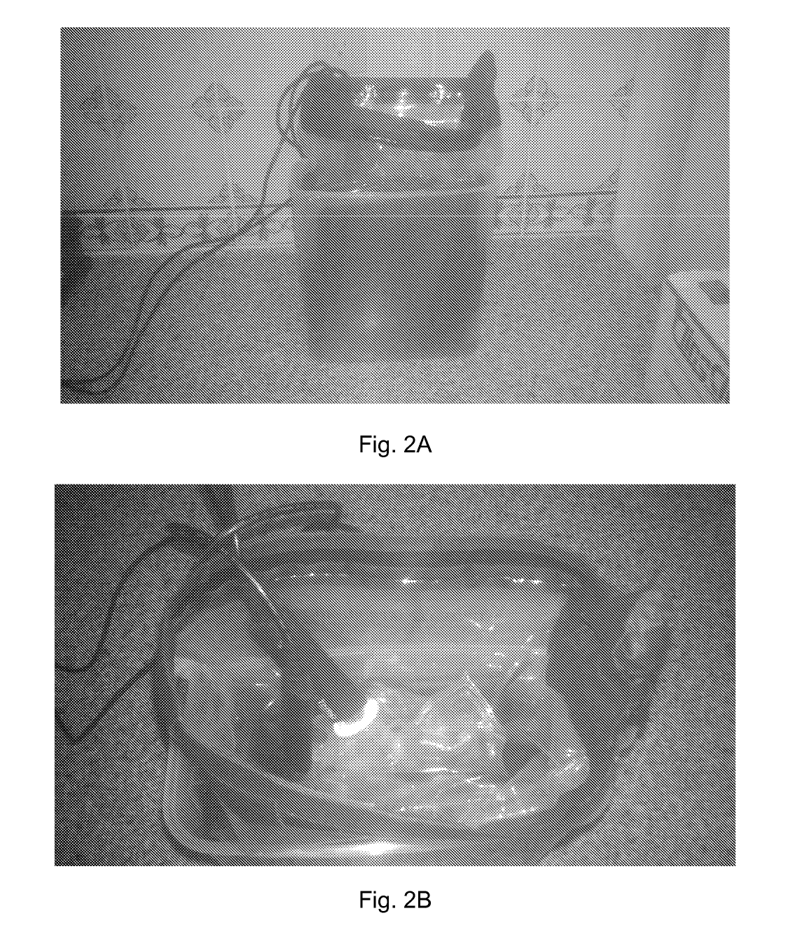

The prototype is shown in FIGS. 1 and 2. In FIG. 2, two thermocouples with external USB leads are shown. These were used to measure the effectiveness of the prototype as described in the next Example. They are not needed for practice of the invention.

### Example 2

This example describes the results of testing the prototype described in Example 1. Two enclosures were chilled to about 2° C. to solidify the PCM, then placed within a TUPPERWARE® polyethylene tub. A blood bag containing saline, Ringer's solution or whole blood was inserted between the two enclosures. Thermocouples were inserted between the enclosures and the blood bag. The prototype was placed at room temperature. No insulation was added. Temperature was measured as a function of time for 0-3 hours. The PCM remained substantially solid for the three hours and the temperature remained constant at 2° C.-4° C. for that time period.

The present invention is not limited to the embodiments described and exemplified herein, but is capable of variation and modification within the scope of the appended claims.

1. A container comprising one or more side, top, bottom and/or internal walls defining one or more internal spaces, wherein one or more of the walls is or includes an enclosure in which is disposed a phase change material, wherein the one or more internal spaces are of a size and shape such that contents of the container, when placed within the one or more internal spaces, are in substantially direct contact with at least one enclosure containing the phase change material.

2. The container of claim 1, wherein the contents of the container are in substantially direct contact with at least two enclosures containing the phase change material.

3. The container of claim 2, wherein the contents of the container are surrounded by one or more enclosures containing the phase change material.

4. The container of claim 1, wherein the phase change material has a melting temperature range within +2° C. of a pre-determined temperature.

5. The container of claim 4, wherein the phase change material has a melting temperature range selected from: (1) about 2° C. to about 6° C.; and (2) about 20° C. to about 24° C.

6. The container of claim 4, which when closed, maintains the contents at the pre-determined temperature range for up to about 18 hours.

7. The container of claim 4, wherein the pre-determined temperature range is about 2° C. to about 6° C. and the phase change material comprises a long chain fatty acid.

8. The container of claim 1, designed to contain contents comprising packages of biological materials.

9. The container of claim 8, wherein the packages of biological materials are packages containing blood or blood components.

10. The container of claim 1, further comprising a device that indicates whether the container is opened after it is initially closed with the contents inside.

11. The container of claim 1, comprising one or more internal walls defining at least two internal spaces, wherein the internal walls are or include enclosures containing the phase change material.

12. The container of claim 1, disposed within a shell.

13. The container of claim 12, comprising insulation between the container and the shell.

14. The container of claim 13, wherein the insulation comprises a vacuum-sealed material.

15. A method of maintaining the temperature of a material within a pre-determined range for up to a pre-determined time without the use of mechanical heating or refrigeration, the method comprising:
a) providing a container comprising one or more side, top, bottom and/or internal walls defining one or more internal spaces, wherein one or more of the walls is or includes an enclosure in which is disposed a phase change material having a melting point within the pre-determined temperature range, wherein the one or more internal spaces are of a size and shape such that contents of the container, when placed within the one or more internal spaces, are in substantially direct contact with at least one enclosure containing the phase change material;
b) equilibrating the material and the container to within the pre-determined temperature range;
c) placing the material into the internal space of the container as its contents;
d) closing the container; and
e) maintaining the container in the closed condition for up to the pre-determined time;
whereby the temperature of the material is maintained within the pre-determined range for up to the pre-determined time without the use of mechanical heating or refrigeration.

16. The method of claim 15, wherein the pre-determined temperature range is between about 2° C. and about 6° C. or between about 20° C. and about 24° C.

17. The method of claim 15, wherein the pre-determined time is about 18 hours.

18. The method of claim 15, wherein the material is a biological material contained within a package.

19. The method of claim 18, wherein the biological material is blood or a component of blood.

20. The method of claim 15, wherein the container further comprises a device that indicates whether the container is opened after it is initially closed with the material inside.

21. The method of claim 18, wherein the packages of biological material and the container are equilibrated to the temperature range in a mechanical refrigeration unit and the packages of biological material are transferred from the mechanical refrigeration unit to the container.

22. The method of claim 21, wherein the packages of biological material are returned to a mechanical refrigeration unit if the container remains closed during the time the packages of biological material are contained within the closed container outside the mechanical refrigeration unit and the pre-determined time period is not reached.
